(19) United States
(12) Patent Application Publication
(10) Pub. No.: US 2007/0246072 A1
(43) Pub. Date: Oct. 25, 2007

(54) Dishwasher and method of controlling the same

(75) Inventor: Yong Hyun Kim, Changwon-si (KR)

Correspondence Address: BIRCH STEWART KOLASCH & BIRCH, PO BOX 747, FALLS CHURCH, VA, 22040-0747, US

(73) Assignee: LG Electronics Inc., Seoul (KR)

(21) Appl. No.: 11/790,436

(22) Filed: Apr. 25, 2007

(30) Foreign Application Priority Data
Apr. 25, 2006 (KR) 10-2006-0037012

(51) Int. Cl. B08B 7/04; B08B 9/20; B08B 3/00

(52) U.S. Cl. 134/18; 134/56 D; 134/58 D; 134/25.2

(57) ABSTRACT

There is provided a dishwasher and a method of controlling the dishwasher. The dishwasher includes a temperature detecting unit for detecting a temperature of washing water supplied, a control unit for calculating an actual washing time in response to the washing water temperature detected by and transferred from the temperature detecting unit, and a display unit for displaying the actual washing time calculated by the control unit.

### BACKGROUND OF THE INVENTION

1. Field of the Invention

The present invention relates to a dishwasher. More particularly, the present invention relates to a dishwasher that can display an actual washing time and a method of controlling the dishwasher.

2. Description of the Related Art

Generally, a dishwasher is a home appliance that washes and dries dishes by spraying washing water to surfaces of the dishes received therein.

The dishwasher is configured to display a washing time that varies in accordance with a washing condition and a washing course that are selected by a user. At this point, washing times for the respective washing courses are preset in a control unit of the dishwasher. The user identifies the washing time displayed on a display unit of the dishwasher and does his/her other works for the washing time.

However, in the dishwasher of the related art, an actual washing time is different from the washing time displayed on the display unit since a washing water heating time varies in accordance with a temperature of the water supplied and an intensity of the voltage applied to a heating unit. Therefore, when the user identifies the washing time displayed on the display unit and does his/her other works, it is difficult for the user to accurately estimate the actual washing time. This causes the dissatisfaction of the consumers.

### SUMMARY OF THE INVENTION

Accordingly, the present invention is directed to a dishwasher and a method of controlling the same that substantially obviates one or more problems due to limitations and disadvantages of the related art.

An object of the present invention is to provide a dishwasher that can display an actual washing time so that the user can accurately estimate the washing time.

Another object of the present invention is to provide a method of controlling the dishwasher.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, there is provided a dishwasher including: a temperature detecting unit for detecting a temperature of washing water supplied; a control unit for calculating an actual washing time in response to the washing water temperature detected by and transferred from the temperature detecting unit; and a display unit for displaying the actual washing time calculated by the control unit.

In another aspect of the present invention, there is provided a dishwasher including: a temperature detecting unit for detecting a temperature of washing water supplied; a power detecting unit for detecting electric power applied to a heating unit; a control unit for calculating an actual washing time in response to information detected by the temperature detecting unit and the power detecting unit; and a display unit for displaying the actual washing time.

In still yet another aspect of the present invention, there is provided a method of controlling a dishwasher including: detecting a temperature of washing water supplied; calculating an actual washing time in response to the detected washing water temperature; and displaying the actual washing time.

In still yet another aspect of the present invention, there is provided a method of controlling a dishwasher including: displaying a basic washing time corresponding to a washing condition selected by a user; detecting a temperature of washing water supplied; and changing the basic washing time into an actual washing time corresponding to the detected washing water temperature and displaying the actual washing time.

In still yet another aspect of the present invention, there is provided a method of controlling a dishwasher including: displaying a basic washing time corresponding to a washing condition selected by a user; detecting a temperature of washing water supplied and electric power applied to a heating unit; and changing the basic washing time into an actual washing time corresponding to the detected washing water temperature and the detected electric power and displaying the actual washing time.

In still yet another aspect of the present invention, there is provided a method of controlling a dishwasher including: selecting a washing condition; displaying a basic washing time corresponding to a preset basic temperature of washing water in accordance with the selected washing condition; detecting a temperature of washing water supplied; and changing the basic washing time into an actual washing time corresponding to the detected washing water temperature and displaying the actual washing time.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a sectional view of a dishwasher according to an embodiment of the present invention;

FIG. 2 is a block diagram of a control system of the dishwasher of FIG. 1 according to a first embodiment of the present invention;

FIG. 3 is a flowchart illustrating an overall washing process of the dishwasher of FIG. 1;

FIG. 4 is a flowchart illustrating a method of controlling the dishwasher of FIG. 1 according to a first embodiment of the present invention;

FIG. 5 is a block diagram of a control system of the dishwasher of FIG. 1 according to a second embodiment of the present invention;

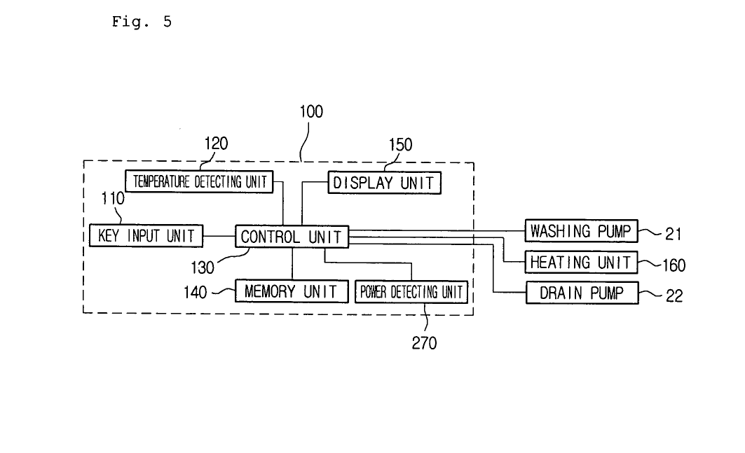

FIG. 6 is a flowchart illustrating a method of controlling the dishwasher of FIG. 1 according to a second embodiment of the present invention.

### DETAILED DESCRIPTION OF THE INVENTION

Reference will now be made in detail to the preferred embodiments of the present invention, examples of which are illustrated in the accompanying drawings. The invention may, however, be embodied in many different forms and should not be construed as being limited to the embodiments set forth herein; rather, these embodiments are provided so that this disclosure will be thorough and complete, and will fully convey the concept of the invention to those skilled in the art.

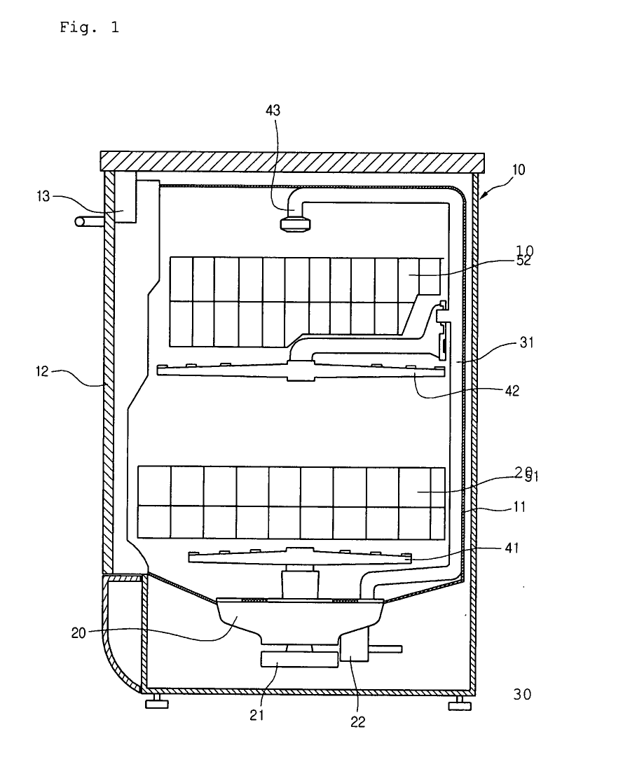

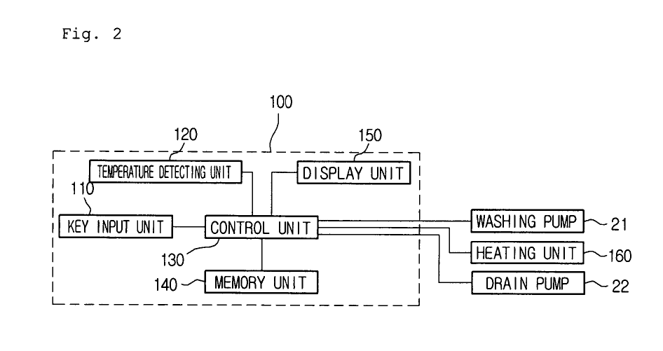

FIG. 1 is a sectional view of a dishwasher according to an embodiment of the present invention and FIG. 2 is a block diagram of a control system of the dishwasher of FIG. 1 according to a first embodiment of the present invention.

Referring to FIG. 1, a dishwasher includes a cabinet defining an outer appearance thereof. A tub 11 defining a washing chamber is disposed in the cabinet 10. A door 12 is pivotally installed on a front portion of the cabinet 10. A control panel 13 is disposed on an upper portion of the door 12.

A sump 20 for storing washing water is disposed under the tub 11. A washing pump 21 for pumping out the washing water and a drain pump 22 for draining the washing water are disposed in the sump 20.

A water guide 31 is connected to the tub 11 to guide the washing water pumped by the washing pump 21.

A plurality of spraying nozzles are connected to the water guide 31. The spraying nozzles may include a lower nozzle 41, an intermediate nozzle 42, and an upper nozzle 43.

Dish racks are disposed in the tub 11. The dish racks may include a lower rack 51 disposed at a lower portion of the tub 11 and an upper rack 52 provided on an upper portion of the tub 11. The lower and upper racks 51 and 52 are installed to be capable of being taken out of the tub 11.

Referring to FIG. 2, the dishwasher includes a control system 100 for controlling the operation of the dishwasher.

The control system 100 includes a key input unit 110 for inputting a washing condition including a washing course, a temperature detecting unit 120 for detecting a temperature of the water supplied, a control unit 130 for receiving water temperature information detected by the temperature detecting unit 120 and calculating a washing time in accordance with the received water temperature information, a memory unit 140 for storing data transferred to the control unit 130, and a display unit 150 for displaying a current washing process.

The memory unit 140 stores the detected values transferred from the temperature detecting unit 120. In addition, data related to the actual washing time corresponding to the temperature of the water supplied are stored as a table form in the memory unit 140.

The temperature detecting unit 120 may be disposed on a fluid passage through which the washing water is supplied. The key input unit 110, the control unit 130, the memory unit 140, and the display unit 150 may be disposed on the control panel 13.

Electrically connected to the control unit 130 are the washing pump 21 and the drain pump 22. A heating unit 160 that may be disposed in the sump 20 is further connected to the heating unit 160. The control unit 130 controls the washing pump 21, the drain pump 22, and the heating unit 160 in accordance with the information received from the key input unit 110 and the temperature detecting unit 120.

The following will describe an overall washing process of the above-described dishwasher of the embodiment of the present invention.

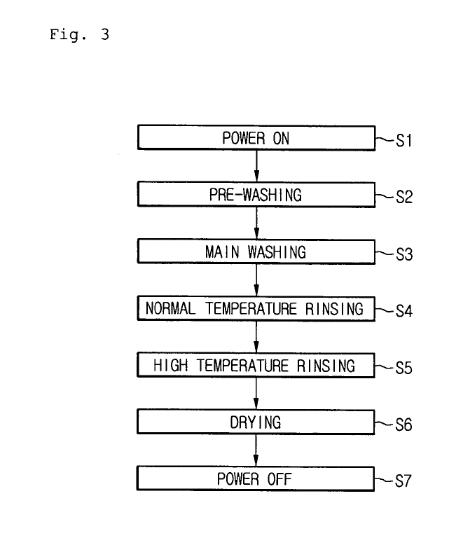

FIG. 3 is a flowchart illustrating an overall washing process of the dishwasher of FIG. 1.

Referring to FIG. 3, after the power of the dishwasher is turned on (S1), a washing condition is input through the key input unit 110. Further, when an operating button of the control panel 13 is pushed, a pre-washing process is performed (S2).

At this point, the washing water is fed into the sump 20. The washing water may be cool water or warm water. The temperature of the washing water may be changed according to the seasons.

When the water is filled in the sump up to a predetermined water level, the supply of the water to the sump 21 is stopped. As the washing pump 21 is driven, the washing water stored in the sump 20 is pumped out. The pumped washing water is fed to the lower nozzle 41 and the water guide 31 simultaneously or alternately. The washing water fed to the lower nozzle 41 is sprayed toward the lower rack 51. The washing water fed to the water guide 31 is sprayed to the upper rack 52 through the intermediate and upper nozzles 42 and 43.

In the pre-washing process, food residues adhered to the dishes are swelled. Thus, the detergent may not be fed.

When the pre-washing process is finished, a drain process is performed.

When the drain process is finished, a main washing process is performed (S3). At this point, clean washing water is fed to the sump 20. In addition, the heating unit 160 is operated during or after the supply of the clean washing water to heat the washing water up to a predetermined temperature. For example, the washing water may be heated up to 65-70° C. Further, the detergent may be fed while the washing water is heated. The fed detergent is uniformly mixed with the washing water. The washing water mixed with the detergent is sprayed toward the dish racks 51 and 52. At this point, the food residues removed from the dishes fall down to the bottom of the tub 11 and filtered off by a filter.

When the main washing process is finished, the drain process is performed again and new washing water is fed to the sump 20. This main washing process may be performed many times.

After the main washing process is finished, a rinsing process is performed. The rinsing process may include a normal temperature rinsing process (S4) and a high temperature rinsing process (S5). At this point, the normal and high temperature rinsing processes may be sequentially performed. Alternatively, only the high temperature rinsing process may be performed.

In the normal rinsing process (S4), the detergent and food residues are firstly removed. After the normal rinsing process is finished, the used washing water is drained and clean washing water is fed. The washing-water is heated.

When the washing water is heated up to a predetermined temperature, the high temperature rinsing process is performed (S5). In this high temperature rinsing process, the detergent and food residues are completely removed from the dishes.

When the high temperature rinsing process is finished, the used washing water is drained and a drying process is performed (S6).

The draying process may be a condensing type drying process or an exhaust type drying process. In the condensing type drying process, humid air circulated by allowing cooling water to flow along a duct during a condensing process is condensed. In the condensing type drying process, since the hot and humid air in the tub 11 is not discharged to the indoor space, the indoor air is not humidified and thus it does not cause the dissatisfaction of the consumers. In the case of the exhaust type drying process, humid air in the tub 11 is discharged to the indoor space. The exhaust type drying process has an advantage to quickly drying the dishes.

After the above-described washing process is finished, the power of the dishwasher is turned off (S7).

The following will describe a method of controlling the dishwasher according to a first embodiment of the present invention.

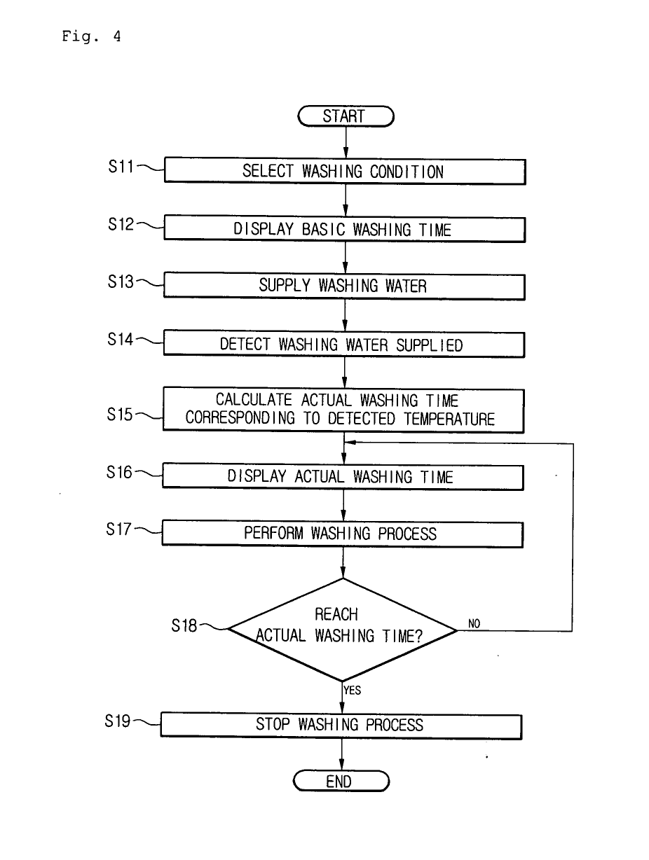

FIG. 4 is a flowchart illustrating a method of controlling the dishwasher of FIG. 1 according to a first embodiment of the present invention.

Referring to FIG. 4, the user selects a washing condition including a washing course through the key input unit 110 (S11). The washing condition includes a full course from the pre-washing process to the drying process, a specific course performing only a specific course, and other sorts of stuffs that may be selected by the user.

When the user selects a washing condition (S11), the control unit 130 calculates a basic washing time stored in the memory unit 140 in response to the selected washing condition. Here, the basic washing time may be determined with reference to at least one of a province where the dishwasher is currently used, a mean temperature of cool water in winter, and a mean temperature of cool water in other seasons. At this point, the reference temperatures are preset in the memory unit 140 by the manufacturer. The reference temperatures will be referred to as “basic waster supply temperature.”

For example, the basic water supply temperature may be determined as any one of a mean temperature (3-5° C.) in winter, a mean temperature (10-18° C.) in seasons other than winter, a mean temperature (30-40° C.) of a warm temperature.

The basic water supply temperature may be varied in accordance with a province where the dishwashers will be sold or a place where the dishwashers will be installed. The basic water supply temperature is a factor that determines a basic heating time of the heating unit 160 when the washing water is supplied.

The basic washing time calculated as described above is displayed on the display unit 150 (S12).

In addition, washing water is fed to the sump 20 (S13). At this point, the temperature detecting unit 120 detects a temperature of the washing water that is being supplied (S14). The detected temperature is sent to the control unit 130. The control unit 130 calculates an actual washing time corresponding to the temperature sent from the detecting unit 120 (S15).

At this time, the actual washing time is set in the memory unit 140 such that the actual washing time is longer than the basic washing time as the temperature of the washing water supplied is reduced. This is because that the time for heating the washing water up to a predetermined temperature becomes longer as the temperature of the washing water supplied is reduced. As described above, since the actual washing time becomes different from the basic washing time in accordance with the temperature of the washing water, the difference is compensated for according to the present invention.

The actual washing time is displayed on the display unit 150 (S16). The control unit performs the washing process in response to the washing condition during the actual washing time (S17). At this point, the user identifies the actual washing time displayed on the display unit and does his/her other works for the washing time.

The control unit 130 performs the selected course while selectively operating the washing pump 21, the drain pump 22, and the heating unit 160.

Next, the control unit 130 determines if a washing time reaches the actual washing time (S18). When it is determined that the washing time reaches the actual washing time, the washing operation is stopped (S19). At this point, the control unit 130 displays the stopping of the washing or rings an alarm.

The following will describe a control system according to a second embodiment of the present invention. Like reference numerals in the first and second embodiments denote like elements, and thus their description will be omitted in the second embodiment.

The control system 100 includes a key input unit 110 for inputting a washing condition including a washing course, a temperature detecting unit 120 for detecting a temperature of the water supplied, a power detecting unit 270 for detecting power applied to the heating unit 160, a control unit 130 for receiving information on the power detected by the power detecting unit 270 and the temperature detected by the temperature detecting unit 120 and calculating a washing time in accordance with the received water temperature information, a memory unit 140 for storing data transferred to the control unit 130, and a display unit 150 for displaying a current washing process.

The memory unit 140 stores information on the temperature of the washing water transferred from the temperature detecting unit 120 and the electric power transferred from the power detecting unit 270. In addition, data related to the actual washing time corresponding to the temperature of the water supplied and the electric power are stored as a table form in the memory unit 140.

The temperature detecting unit 120 may be disposed on a fluid passage through which the washing water is supplied. The key input unit 110, the control unit 130, the memory unit 140, and the display unit 150 may be disposed on the control panel 13.

The power detecting unit 270 may be disposed on the fluid passage through which the washing water is fed. The power detecting unit 270 detects the power if the power is 110V or 220V and transfers the detected power information to the control unit 130.

The actual washing time corresponding to the temperature of the washing water supplied when the 110V is applied and the actual washing time corresponding to the temperature of the washing water supplied when the 220V is applied are set as the table form by each washing condition in the memory unit 140.

Here, when it is assumed that the temperature and amount of the washing water supplied are uniform, a heating time required for heating the washing water by the 110V heating unit is 1.5-2 times a heating time required for heating the washing water by the 220V heating unit. Therefore, the washing time required when the 110V heating unit is used may be set to be longer than the washing time required when the 220V heating unit is used by 1.5-2 times. Needless to say, the actual washing time may vary in accordance with an amount of the washing water supplied.

Electrically connected to the control unit 130 are the washing pump 21 and the drain pump 22. A heating unit 160 that may be disposed in the sump 20 is further connected to the heating unit 160. The control unit 130 controls the washing pump 21, the drain pump 22, and the heating unit 160 in accordance with the information received from the key input unit 110, the temperature detecting unit 120, and the power detecting unit 270.

Since the washing process of the dishwasher having the control system of this second embodiment is substantially identical to that of the dishwasher having the control system of the first embodiment, a description thereof will be omitted herein.

The following will describe a method of controlling the dishwasher according to a second embodiment of the present invention.

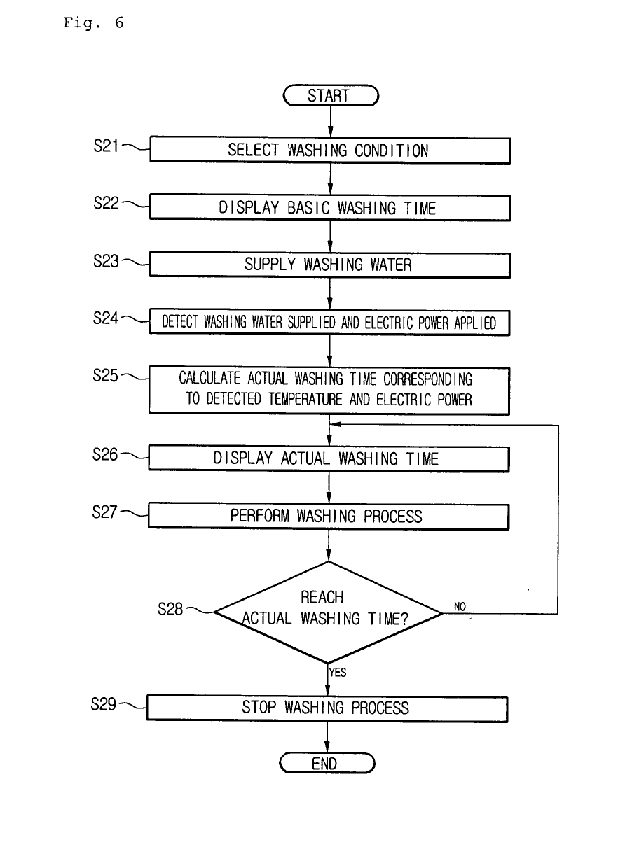

FIG. 6 is a flowchart illustrating a method of controlling the dishwasher of FIG. 1 according to a second embodiment of the present invention.

Referring to FIG. 6, the user selects a washing condition including a washing course through the key input unit 110 (S21).

When the user selects a washing condition (S21), the control unit 130 calculates a basic washing time stored in the memory unit 140 in response to the selected washing condition. Here, the basic washing time may be determined with reference to at least one of a province where the dishwasher is currently used, a mean temperature of cool water in winter, and a mean temperature of cool water in other seasons. At this point, the reference temperatures are preset in the memory unit 140 by the manufacturer. The reference temperatures will be referred to as “basic waster supply temperature.”

For example, the basic water supply temperature may be determined as any one of a mean temperature (3-5° C.) in winter, a mean temperature (10-18° C.) in seasons other than winter, a mean temperature (30-40° C.) of a warm temperature.

The basic water supply temperature may be varied in accordance with a province where the dishwashers will be sold or a place where the dishwashers will be installed. The basic water supply temperature is a factor that determines a basic heating time of the heating unit 160 when the washing water is supplied.

The basic washing time calculated as described above is displayed on the display unit 150 (S22).

In addition, washing water is fed to the sump 20 (S23). At this point, the temperature detecting unit 120 detects a temperature of the washing water that is being supplied (S24). The detected temperature is sent to the control unit 130.

Electric power is applied to the heating unit 160 during or after the supply of the washing water. At this point, the power detecting unit 270 detects a voltage of the electric power applied to the heating unit 160 and sends the detected voltage information to the control unit 130 (S24). That is, the power detecting unit 270 detects if the electric power applied is 110V or 220V and sends the detected result to the control unit 130.

The control unit 130 calculates an actual washing time corresponding to the detected water temperature and the detected power voltage (S25).

At this time, the actual washing time is set in the memory unit 140 such that the actual washing time is longer than the basic washing time as the temperature of the washing water supplied is reduced and the actual washing time required when 110V power is applied is longer than the actual washing time required when 220V power is applied.

As described above, since the actual washing time becomes different from the basic washing time in accordance with the temperature of the washing water and the power voltage applied, the difference is compensated for according to the present invention.

The actual washing time is displayed on the display unit 150 (S26). The control unit 130 performs the washing process in response to the washing condition during the actual washing time (S27). At this point, the user identifies the actual washing time displayed on the display unit 150 and does his/her other works for the washing time.

The control unit 130 performs the selected course while selectively operating the washing pump 21, the drain pump 22, and the heating unit 160.

Next, the control unit 130 determines if a washing time reaches the actual washing time (S28). When it is determined that the washing time reaches the actual washing time, the washing operation is stopped (S29). At this point, the control unit 130 displays the stopping of the washing or rings an alarm.

The dishwasher of the present invention has the following advantages.

Since the washing time displayed on the display unit is almost identical to the actual washing time, the reliability of the products and the satisfaction of the consumers can be significantly improved.

Further, since the washing time displayed on the display unit is almost identical to the actual washing time, the user can do his/her other works and thus work efficiency can be improved.

It will be apparent to those skilled in the art that various modifications and variations can be made in the present invention. Thus, it is intended that the present invention covers the modifications and variations of this invention provided they come within the scope of the appended claims and their equivalents.

What is claimed is:

1. A dishwasher comprising:
a temperature detecting unit for detecting a temperature of washing water supplied;
a control unit for calculating an actual washing time in response to the washing water temperature detected by and transferred from the temperature detecting unit; and
a display unit for displaying the actual washing time calculated by the control unit.

2. The dishwasher according to claim 1, further comprising a memory unit for storing the actual washing time corresponding to the detected water temperature.

3. The dishwasher according to claim 1, wherein, after a basic washing time corresponding to a washing condition selected by a user is displayed on the display unit, the basic washing time is changed into the actual washing time corresponding to the detected washing water temperature.

4. A dishwasher comprising:
a temperature detecting unit for detecting a temperature of washing water supplied;
a power detecting unit for detecting electric power applied to a heating unit;
a control unit for calculating an actual washing time in response to information detected by the temperature detecting unit and the power detecting unit; and
a display unit for displaying the actual washing time.

5. The dishwasher according to claim 4, wherein the control unit stores the actual washing time corresponding to the detected washing water temperature and the detected electric power.

6. The dishwasher according to claim 4, wherein, wherein, after a basic washing time corresponding to a washing condition selected by a user is displayed on the display unit, the basic washing time is changed into the actual washing time corresponding to the detected washing water temperature and the detected electric power.

7. A method of controlling a dishwasher comprising:
detecting a temperature of washing water supplied;
calculating an actual washing time in response to the detected washing water temperature; and
displaying the actual washing time.

8. The method according to claim 7, wherein, after a basic washing time corresponding to a washing condition selected by a user is displayed on the display unit, the basic washing time is changed into the actual washing time corresponding to the detected washing water temperature.

9. The method according to claim 8, wherein the basic washing temperature is determined with reference to any one of a mean temperature of cool water in winter, a mean temperature of cool water in seasons other than winter, and a temperature of warm water.

10. The method of claim 7, wherein actual washing times corresponding to a plurality of temperature ranges of the washing water supplied are stored.

11. A method of controlling a dishwasher comprising:
displaying a basic washing time corresponding to a washing condition selected by a user;
detecting a temperature of washing water supplied; and
changing the basic washing time into an actual washing time corresponding to the detected washing water temperature and displaying the actual washing time.

12. A method of controlling a dishwasher comprising:
displaying a basic washing time corresponding to a washing condition selected by a user;
detecting a temperature of washing water supplied and electric power applied to a heating unit; and
changing the basic washing time into an actual washing time corresponding to the detected washing water temperature and the detected electric power and displaying the actual washing time.

13. A method of controlling a dishwasher comprising:
selecting a washing condition;
displaying a basic washing time corresponding to a preset basic temperature of washing water in accordance with the selected washing condition;
detecting a temperature of washing water supplied; and
changing the basic washing time into an actual washing time corresponding to the detected washing water temperature and displaying the actual washing time.

14. The method according to claim 13, wherein the basic water temperature is within a range of 3-5° C., 10-18° C., or 30-40° C.
